(19) United States
(12) Patent Application Publication
(10) Pub. No.: US 2025/0246844 A1
(43) Pub. Date: Jul. 31, 2025

(54) ELECTRICAL CONNECTOR

(71) Applicants: APTIV CONNECTION SYSTEMS (NANTONG) LTD., Jiangsu (CN); APTIV ELECTRICAL CENTERS (SHANGHAI) CO. LTD., Shanghai (CN)

(72) Inventors: Xiaoxian TIAN, Shanghai (CN); Haifei GUAN, Shanghai (CN)

(21) Appl. No.: 19/037,358

(22) Filed: Jan. 27, 2025

(30) Foreign Application Priority Data
Jan. 25, 2024 (CN) 202410113450.5

(51) Int. Cl. H01R 13/502; H01R 13/02; H01R 13/52; H01R 13/627

(52) U.S. Cl. CPC H01R 13/502; H01R 13/025; H01R 13/5202; H01R 13/5213; H01R 13/6273

(57) ABSTRACT

An electric connector includes a main shell defining an inner space along a first direction, with a terminal channel provided within the main shell. The connector includes a plurality of secondary components, including a terminal locking component and an end cover component. The terminal locking component is designed to be contained within the main shell, while the end cover component is configured to mate with the rear end of the main shell. The end cover component and the main shell can be pre-assembled in a first positional relationship that includes a gap and can be fully mated in a second positional relationship with no gap, ensuring secure assembly and reliable electrical connection.

### CROSS-REFERENCE TO RELATED APPLICATION

This application claims benefit of priority to Chinese Patent Application No. 202410113450.5 filed on Jan. 25, 2024, the entire disclosure of which is hereby incorporated by reference.

### TECHNICAL FIELD OF THE INVENTION

This application relates to electric connector, including but not limited to the field of coaxial electrical connector technology.

### BACKGROUND

Electric connectors are essential components in a wide range of electronic devices and systems, providing the necessary interface for electrical signals and power to be transmitted between different parts of a system. Traditional electric connectors often consist of a main shell that houses various terminals and components, which are typically assembled in a fixed configuration. These connectors are designed to ensure secure and reliable connections, but they can be limited in terms of flexibility and case of assembly. In many cases, the assembly process requires precise alignment and insertion of components, which can be time-consuming and prone to errors.

Previous approaches to improving electric connectors have focused on enhancing the locking mechanisms and the structural integrity of the connectors. Some designs incorporate terminal locking components that secure the terminals within the main shell, preventing dislodgement and ensuring consistent electrical contact. These locking components are often integrated into the main shell or added as separate elements, requiring additional assembly steps. Furthermore, end cover components are commonly used to protect the rear end of the connector and provide strain relief for the connected cables. However, these end covers are typically designed to be permanently fixed to the main shell, limiting the ability to adjust or reconfigure the connector after initial assembly.

Efforts to address these limitations have led to the development of connectors with pre-assembly features, allowing for a preliminary positioning of components before final assembly. This approach aims to simplify the assembly process by enabling components to be initially aligned with a gap, which can then be closed during final assembly to achieve a secure fit. While these designs offer some improvements in terms of assembly efficiency and flexibility, they often involve complex mechanisms or additional parts that can increase manufacturing costs and complexity.

At present, when developing an electric connector, such as a coaxial water-proof mini-connector, a design consisting of several loose pieces are usually adopted, wherein several different components are to be packed individually and then delivered. an assembly operator of a customer at the downstream end, after receiving these loose pieces, must first assemble these loose pieces together, and then put the cable, with attached terminal, into the connector and locking it in. Additional operation time is required for assembling all these loose pieces.

However, none of these approaches have provided a comprehensive solution that combines the features described in this disclosure.

### SUMMARY

This application proposes an electric connector having components with pre-assembly design, so as to reduce the operation time for the operator at customer end to assemble loose pieces.

According to an aspect of this application, an electric connector is provided, the electric connector includes a main shell defining an inner space extending along a first direction, a terminal channel is provided within the main shell and a plurality of secondary components. The secondary components include a terminal locking component and an end cover component. The terminal locking component configured to be contained within the main shell, and the end cover component configured to be mated with the rear end of the main shell. The end cover component and the main shell are capable of being pre-assembled together in a first positional relationship having a gap, and are capable of being fully mated in a second positional relationship with no gap.

As compared with the prior art, the electric connector proposed by this application has main shell and secondary components which can be pre-assembled together and can be delivered to downstream customer in the pre-assembled status, such that a subsequent terminal insertion operation can be carried out directly.

### BRIEF DESCRIPTION OF THE DRAWINGS

In order to provide a clearer explanation of the technical solution in the embodiments of the present application, a brief introduction will be given to the drawings to be used for depicting the embodiments. It is obvious that the drawings described below are only some embodiments of the present application. For those skilled in the art, other drawings can be conceived based on these drawings without creative labor.

FIG. 1 is a perspective view of an electric connector being in a delivery state according to some embodiments.

FIG. 2 is a side view of an electric connector being in a final locking state according to some embodiments.

FIG. 3 is an exploded perspective view of a main shell and secondary components in an electric connector according to some embodiments.

FIG. 4A is an exploded perspective view of the secondary components in FIG. 3 according to some embodiments.

FIG. 4B is an exploded perspective view of the secondary components in FIG. 3, from another angle of view according to some embodiments.

FIG. 5 is a cross-sectional view of the electric connector according to some embodiments.

FIG. 6 is a perspective view of the main shell of the electric connector according to some embodiments.

FIG. 7 is a cross-sectional view of the main shell of the electric connector according to some embodiments.

FIG. 8 is a perspective view of the terminal locking component in of the electric connector according to some embodiments.

FIG. 9 is a perspective view of the end cover component in of the electric connector according to some embodiments.

FIG. 10 is a perspective view of the seal component in of the electric connector according to some embodiments.

FIGS. 11A, 11B, 11C, 11D, 11E, 11F, 11G, 11H, and 11I illustrate the assembling steps for an electric connector according to some embodiments.

### DETAILED DESCRIPTION

The following will, with reference to the accompanying drawings for the embodiments, provide a clear and complete description of the technical solution the present application. Obviously, the embodiments being depicted are only a part of the embodiments of the present application, not all of them. Based on the embodiments being depicted in this application, all other implementations that would be obtained by those skilled in the art without creative labor are within the scope of protection of this application.

In the description of this application, it should be understood that the terms “center”, “up”, “down”, “front”, “back”, “left”, “right”, “vertical”, “horizontal”, “top”, “bottom”, “inside”, “outside” and other directional or positional relationships indicated are based on the accompanying drawings and are only for the convenience of describing this application and simplifying the description, and do not indicate or imply that the device or component referred to must have such a specific orientation, be constructed and operated in such a specific orientation, and therefore these terms shall not be understood as a limitation of this application.

The terms “first” and “second” are only used for descriptive purposes and shall not be understood as indicating or implying relative importance or implying the number of technical features indicated. Thus, a feature being defined by “first” and “second” may explicitly or implicitly include one or more additional such features. In the description of this application, unless otherwise specified, the meaning of “multiple” refers to two or more.

In the description of this application, it should be noted that unless otherwise specified and limited, the terms “install”, “connect”, and “couple” should be broadly understood, for example, they may refer to fixed connections, detachable connections, or integral connections; they may refer to a mechanical connection, a direct connection, an indirect connection through an intermediate medium, or an internal communication between two components. For those skilled in the art, the specific meanings of the above terms in this application may be understood according to specific situations.

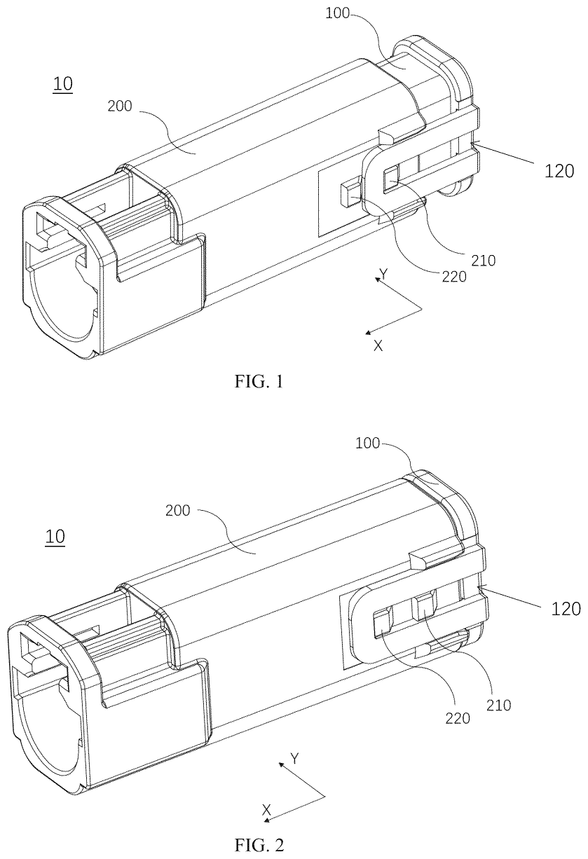

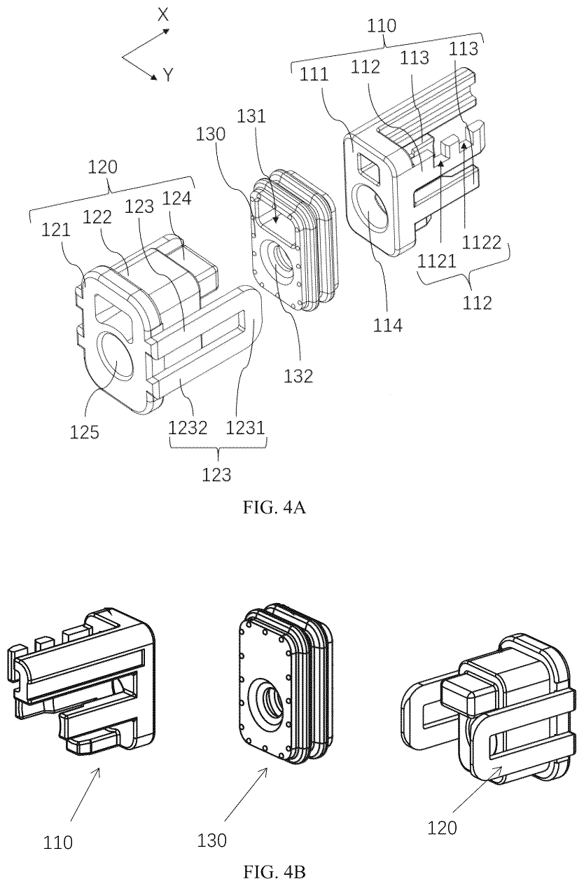

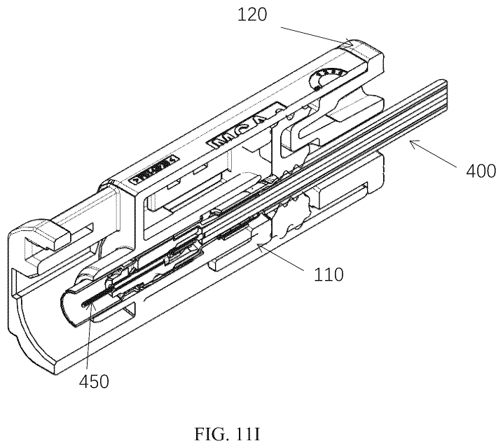

An electric connector 10 (or referred to as “connector”) is proposed according to an embodiment of this application, the electric connector 10 is extending along a first direction X, and is to contain and secure electrical terminal, such as an electrical terminal 450 mounted at end of a cable 400 (shown in FIG. 11G). With reference to FIG. 3, the electric connector 10 includes a main shell 200, and includes several secondary components 100 including terminal locking component 110, end cover component 120 and seal component 130. The main shell 200 has a front end and a rear end which are in communication with each other, and the main shell 200 defines an inner space extending from the first direction X. The main shell 200 is provided with terminal channel for containing and securing terminal 450. The terminal locking component 110 and the seal component 130 are to be inserted into the man shell 200 in sequence from the rear end, and then the end cover component 120 configured to be mated with the rear end of the main shell 200, and to be latched with first fixing portions 210 at two lateral sides of the main shell 200, to form a delivery state as shown in FIG. 1. Under this situation, the man shell 200 and the various secondary components 100 are in a pre-assembled relationship, wherein the main shell 200 and end cover component 120 are connected to each other but with a gap, forming a first positional relationship.

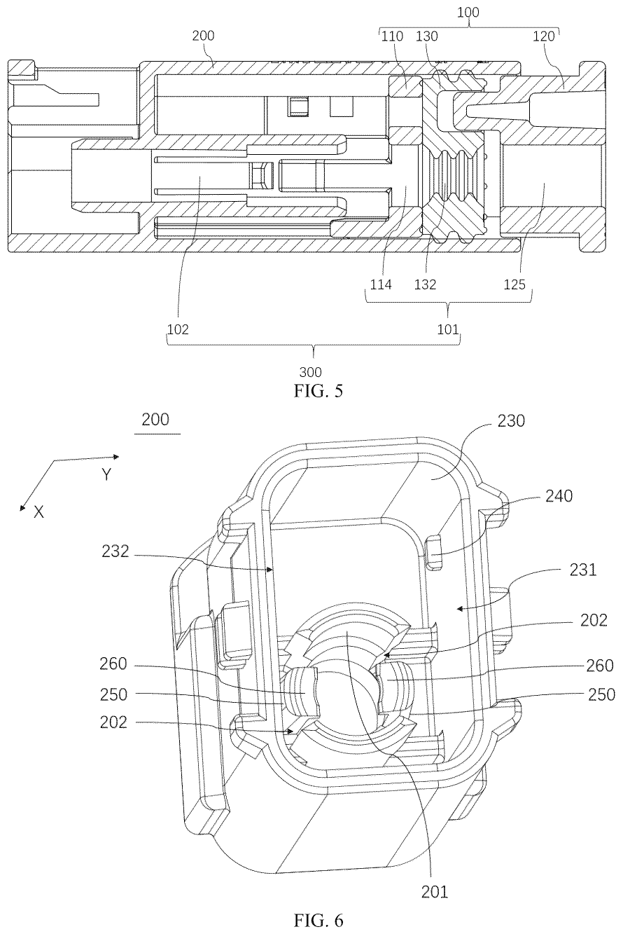

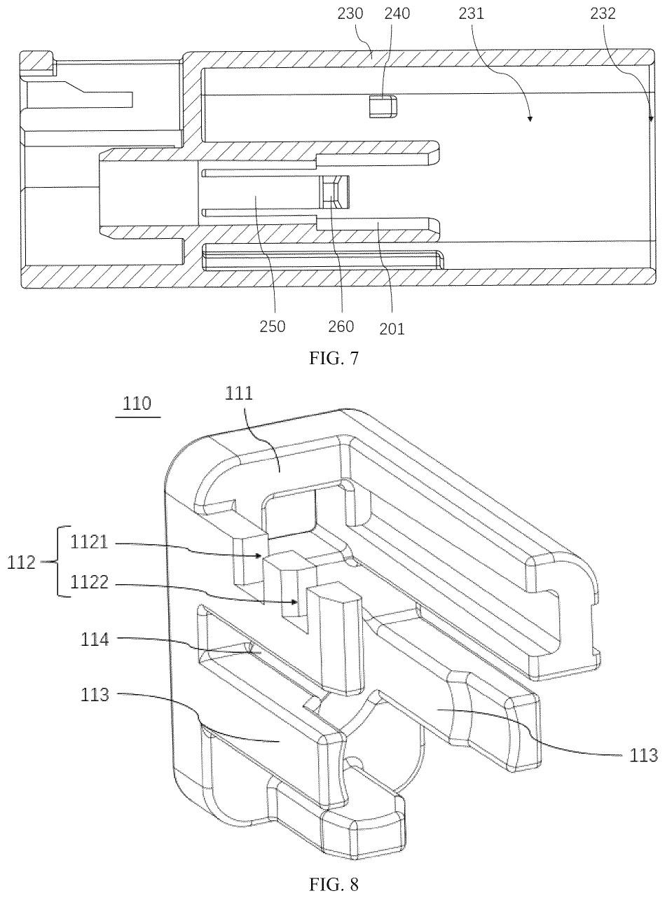

Further referring to FIGS. 4A and 5, a through-hole 125 is formed in the end cover component 120, and a first through-hole 132 is provided in the seal component 130, and a second through-hole 114 is provided in the terminal locking component 110. The first through-hole 132 and the second through-hole 114 are in communication to form a first through-slot 101 for terminal 450 and cable 400 to enter and exit. In the main shell 200, a terminal channel 102 is provided to contain and secure the terminal 450. The first through-slot 101 are in communication with the terminal channel 102 to form a connection channel 300. Thus, the terminal 450 and cable 400 can be directly mounted within the electric connector 10 in delivery state as shown in FIG. 1.

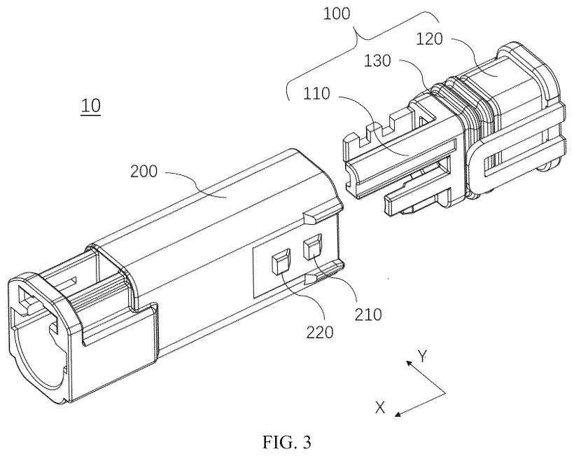

As shown in FIG. 2, the latching position between the end cover component 120 and the main shell 200 can be adjusted from the first fixing position to the second fixing position, at this time, the electric connector 10 in delivery state as shown in FIG. 1 can be switched to the electric connector 20 in final locking state as shown FIG. 2. At this time, the main shell 200 and the various secondary components 100 are in a second positional relationship (also referred to as final locking relationship, assembled relationship, or fully mated relationship), wherein the main shell 200 and the end cover component 120 are connected with each other with no gap.

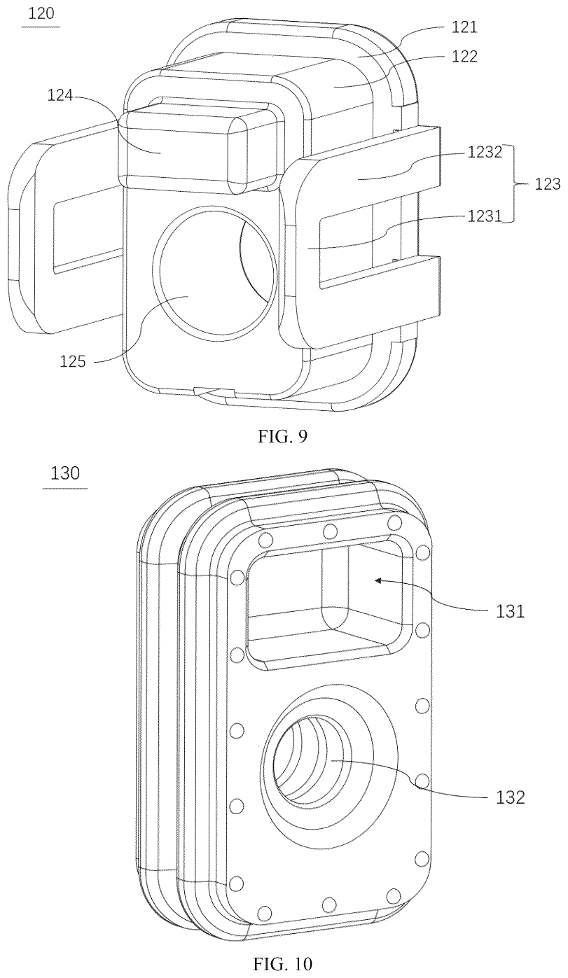

Referring now to FIG. 6, the main shell 200 includes a housing 230 having a cavity 231 and an opening 232. The main shell 200 further includes a second through-slot structure 201. The second through-slot structure 201 is provided in the cavity 231, and the cavity 231 is in communication with the opening 232. The terminal 450 and the cable 400 connected with terminal 450 can be entered into the cavity 231 through the opening 232 from the rear side of the main shell 200, and pass through cavity 231, to enter into the second through-slot structure 201. Finally, the terminal 450 configured to be secured within the terminal channel due to the force applied by the second through-slot structure 201.

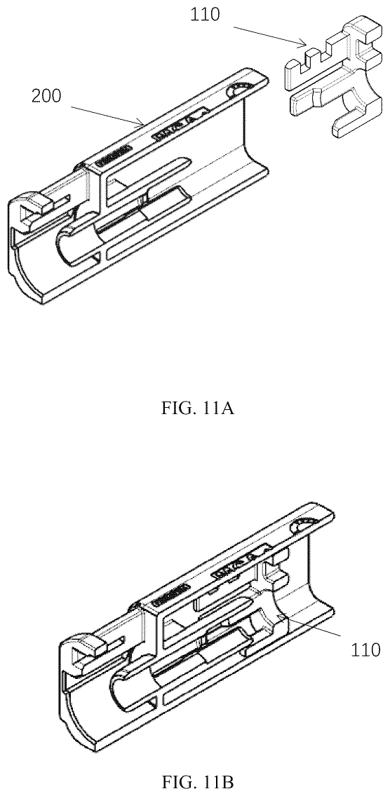

Referring now to FIGS. 1, 2, 3, 5, 6, and 7, a part of the end cover component 12 is to enter through the rear opening 232 of the main shell 200 and configured to be mounted within the cavity 231, and meanwhile, locking arms at both sides of the end cover component 120 configured to be connected with locking protrusions on outer wall of the housing 230, such that the end cover component 120 and main shell 200 are mated.

Referring now to FIGS. 1, 2, 3, and 9, both first fixing portion 210 and second fixing portion 220 are at outer wall of the housing 230. When end cover component 120 is mated with the main shell 200, the end cover component 120 may be first have a position restricted by the first fixing portion 210, at this time the main shell 200 and various components 100 of the electric connector 10 are already pre-assembled together for the terminal 450 and cable 400 to enter through. Thus, the operator at downstream customer side, after receiving the electric connector 10 in delivery state, can put the cable 400 (terminal 450 included) directly into the electric connector 10. The procedure for the downstream customer side to assemble loose pieces is eliminated.

Still referring to FIGS. 1, 2, 3 and 9, after the terminal 450 and cable 400 are placed into the electric connector 10 in delivery state, the relative position between end cover component 120 and main shell 200 can be adjusted, such that the end cover component 120 will have a position restricted by the second fixing portion 220, which, as compared to the first fixing portion 210, is further away from the rear end of the main shell 200. Under this situation, the end cover component 120 will push the terminal locking component 110 to move forward, so as to make the terminal locking component 110 apply larger retaining force to terminal 450 within the main shell 200, so as to achieve locking and fixation function for the terminal 450.

As shown in FIGS. 5, 6, 7, the main shell 200 further includes an internal positioning portion 240, the internal positioning portion is connected with the housing 230 and is provided within the cavity 231. The internal positioning portion 240 configured to be latched with the terminal locking component 110 under different positional relationships.

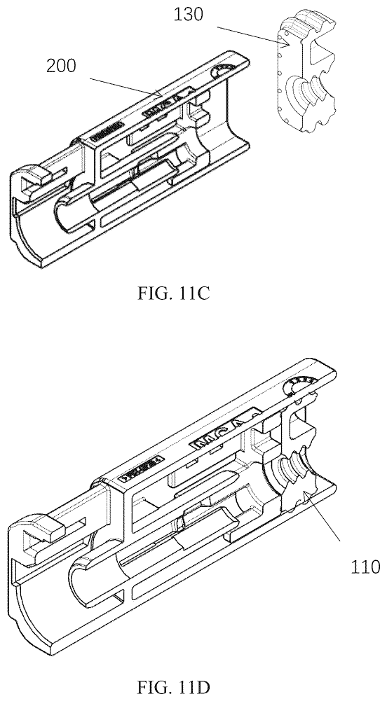

As shown in FIGS. 3, 4A, 4B, 5, 6, 7, and 8, the terminal locking component 110 includes a substrate 111 and a latching arm 112. Along the first direction X, the latching arm 112 is at a side of the substrate which is away from the end cover component 120, such that when the substrate 111 is moving along the first direction X when being pushed by the end cover component 120, the latching arm 112 is switched from a first relative position to a second relative position.

In some embodiments, one end of the latching arm 112 is connected with the substrate 111. The latching arm 112 has a first latching notch 1121 and a second latching notch 1122, and the internal positioning portion 240 configured to be latched by the first latching notch 1121 or the second latching notch 1122.

When the end cover component 120 is latched by the first fixing portion 210, the internal positioning portion 240 configured to be latched with the second latching notch 1122 on the latching arm 112 to achieve the first relative position, and when the end cover component is latched by the second fixing portion 220, the internal positioning portion 240 configured to be latched with the first latching notch 1121 on the latching arm 112 to achieve the second relative position.

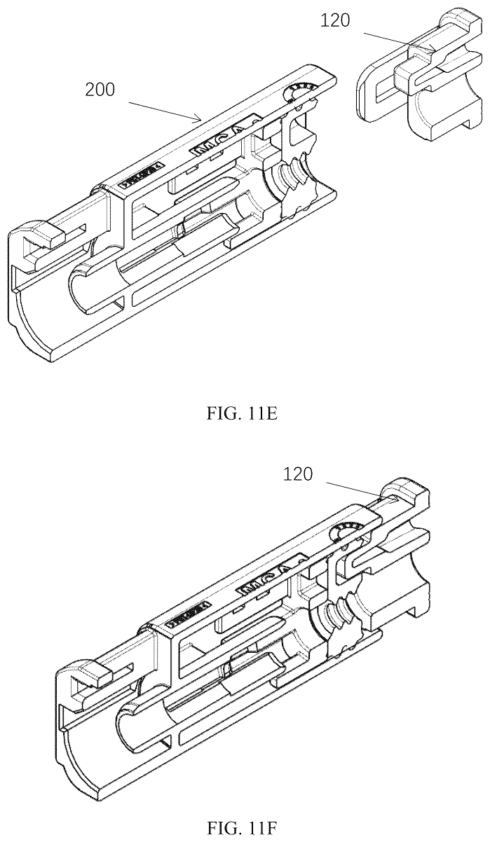

Referring now to FIGS. 3, 4A, 4B, 5, 6, and 9, the end cover component 120 includes a push block 122 and end cover latching arms 123. The push block 122 configured to be inserted into the opening 232, and at least a portion of the push block 122 configured to be pushed into the cavity 231. The push block 122 is configured to push against the terminal locking component 110 and optional seal component 130 along the first direction X, such that the terminal locking component 110 is switched from the first relative position to the second relative position. The end cover latching arms 123 are connected with the push block 122 and positioned at a side of the push block 122 closer to the main shell 200. The end cover latching arms 123 are configured to have a position restricted by the first fixing portion or the second fixing portion. When the terminal locking component 110 is at the first relative position, the end cover latching arms 123 are restricted by the first fixing portion 210, and when the terminal locking component 110 is at the second relative position, the end cover latching arms 123 are restricted by the second fixing portion 220. Further referring to FIGS. 4A, 4B and 9, the end cover component 120 further includes a cover plate 121, the cover plate 121 is connected with the push block 122, and the cover plate 121 is at a side of the push block 122 which is away from the terminal locking component 110. The front projection of the cover plate 121 covers opening 232 to seal it.

Referring now to FIGS. 1, 2, 3, 4A-4B, and 9, the end cover latching arms 123 may have a simply supported beam structure, which consists of a pair of supporting rods 1231 and a connection rod 1232 connected with the supporting rods 1231.

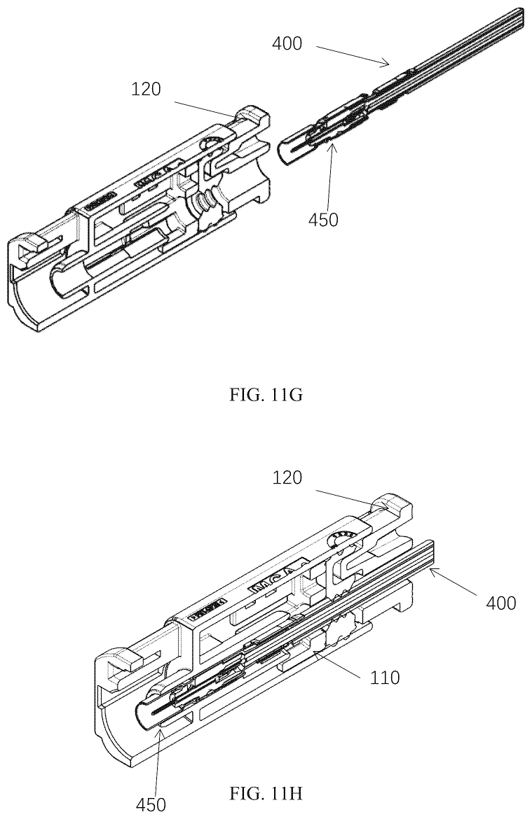

Referring now to FIGS. 3, 4A-4B, 5, and 10, the seal component 130 configured to be scaled with the housing 230 and configured to be within the cavity 231. In particular, one end of the seal component 30 is to abut with the substrate 111, and the other end of the seal component is configured to abut with the push block 122. In some embodiment, the seal component 130 includes a positioning groove 131, which has an opening facing the end cover component 120. The end cover component 120 further includes a positioning convex portion 124 which is connected with the push block 122 and is at a side of the push block 122 which is closer to the seal component 130. When the end cover component 120 is having a position restricted by the first fixing portion 210, the positioning convex portion 124 configured to be at least partially inserted into the positioning groove 131, and when the end cover component 120 is having a position restricted by the second fixing portion 220, the positioning convex portion 124 configured to be inserted in the positioning groove 131.

As shown in FIGS. 3-8, the terminal locking component 110 further includes two first locking plates 113, and the main shell 200 further includes two second locking plates 250, the first locking plate 113 is configured to be pressed against the second locking plate 250, so as to apply retaining force to terminal 450.

Still referring to FIGS. 3-8, the first locking plate 113 is extending along the first direction X, and one end of the first locking plate 113 is connected with the substrate 111. Two locking plates 113 are arranged in symmetry along the second direction Y which is perpendicular to the first direction X. Along the second direction Y, the two second locking plates 250 are at two sides of the first through-slot 101. In some embodiment, the second locking plate 250 is extending along the first direction, and one end of the second locking plate 250 is connected with the second through-slot structure 201. In some embodiment, along the second direction Y, the second locking plate 250 is at one side of the first locking plate 113 which is closer to the second through-slot structure 201. When the end cover component 120 has a position restricted by the second fixing portion 220, the first locking plate 113 contacts the second locking plate 250.

As shown in FIG. 6, at the end of the second locking plate 250, protrusion structure is formed to provide better effect of retaining terminal 450. In some embodiments, along the first direction X, the orthographic projection of the third protrusion 260 is partially overlapping with the slot-hole of the second through-slot structure 201, such that the third protrusion 260 enters into the connection channel 300. A radial contact force is applied by the first locking plate 113 to the second locking plate 250, and the second locking plate 250 is to transfer the contact force to the third protrusion 260, and the third protrusion 260 is to retain the terminal 450 within the connection channel 300. In some embodiment, at slotted wall of the second through-slot structure 201, there are two clearance slots 202 extending along the first direction X. In some embodiment, the two clearance slots are arranged in symmetry along the second direction Y. In some embodiment, two second locking plates are located within the two clearance slots 202 respectively.

FIGS. 11A-11I illustrate the assembling steps of the electric connector 10. Through the steps shown in FIGS. 11A-11F, an electric connector 10 in delivery state is assembled. Through the steps shown in FIGS. 11G-11H, terminal 450 and cable 400 are placed into the electric connector 10 in delivery state. Through the step shown in FIG. 11I, the end cover component 120 and the main shell 200 are further locked, at this time, the terminal locking component 1110 is pushed forward to apply enhanced terminal retaining force so as to obtain an electric connector 10 in the final locked state.

In the embodiment of this application, an electric connector 10 having a single port for terminal is illustrated. It is appreciated that this application is not limited to this and shall include an electric connector having multiple ports for terminals, and accordingly, the number of through-holes in the end cover component and seal component can be increased, and further, the number of through-holes in the terminal locking component can be increased.

In the embodiment, an electric connector 10 having seal component 130 is illustrated. It is appreciated that the use of seal component 130 is to meet the water-proof demand of some specific application. In some implementation, there is no need to use seal.

This application provides a detailed introduction to a connector provided in the embodiments of the present application. Specific examples are provided to explain the principles and implementation methods of the present application. The above embodiments are only used to help understand the method and core idea of the present application. Meanwhile, for a person skilled in the art, based on the ideas of this application, changes in the specific implementation approaches are possible. Therefore, the content of this specification should not be understood as limiting this application.

1. An electric connector, comprising:
a main shell defining an inner space extending along a first direction, the main shell defining a terminal channel within; and
a plurality of secondary components, the secondary components comprising a terminal locking component and an end cover component, the terminal locking component configured to be contained within the main shell, and the end cover component configured to be mated with a rear end of the main shell, wherein the end cover component and the main shell are capable of being pre-assembled together in a first positional relationship having a gap, and are capable of being fully mated in a second positional relationship with no gap.

2. The electric connector of claim 1, wherein the end cover component comprises a clamping structure, the clamping structure configured to be clamped onto a first fixing portion on the main shell for the first positional relationship and, the clamping structure configured to be clamped onto a second fixing portion on the main shell for the second positional relationship and wherein the first fixing portion is closer to the rear end of the main shell than the second fixing portion.

3. The electric connector of claim 1, wherein, the electric connector is in a delivery state when the end cover component and the main shell are in the first positional relationship, and the electric connector is in a final locked state when the end cover component and the main shell are in the second positional relationship.

4. The electric connector of claim 1, wherein the end cover component is to directly or indirectly push the terminal locking component to move towards a front end of the electric connector when the end cover component and the main shell are fully mated, so as to apply enhanced terminal retaining force to terminal within the terminal channel.

5. The electric connector of claim 2, wherein the main shell comprises a housing, the housing has a cavity and an opening facing the rear end of the electric connector, the cavity and the opening are in communication, the terminal locking component configured to be arranged within the cavity, and the end cover component is to at least partially enter into the opening, and the first fixing portion and the second fixing portion are disposed on outer wall of the housing.

6. The electric connector of claim 5, wherein the end cover component further comprises:
a push block configured to be mated within the opening such that the push block is at least partially positioned within the cavity, and the push block is configured to be push the terminal locking component along the first direction; and
an end cover latching arm is connected with the push block, and is at a side of the push block, which is closer to the main shell, the end cover latching arm is configured to have a position restricted by the first fixing portion or the second fixing portion.

7. The electric connector of claim 6, wherein the end cover latching arm has a simply supported beam structure.

8. The electric connector of claim 6, wherein the plurality of secondary components further comprises a seal component to be sealed with the housing and to be disposed within the cavity, wherein the seal component is configured to be disposed between the terminal locking component and the end cover component.

9. The electric connector of claim 8, wherein the seal component has a positioning groove, defining an opening facing the end cover component, wherein the end cover component further comprises a positioning convex portion, the positioning convex portion is connected with the push block, and the positioning convex portion is configured to be disposed within the positioning groove.

10. The electric connector of claim 5, wherein the main shell further comprises an internal positioning portion connected with the housing and disposed within the cavity.

11. The electric connector of claim 10, wherein the terminal locking component further comprises:
a substrate configured to be abutted with the end cover component along the first direction; and
a latching arm extending along the first direction, the latching arm having one end connected with the substrate, a first latching notch, and a second latching notch, wherein the internal positioning portion is configured to be latched with the first latching notch or the second latching notch and wherein, the internal positioning portion is configured to be latched with the first latching notch when the end cover component has a position restricted by the second fixing portion and, the internal positioning portion is configured to be latched with the second latching notch when the end cover component has a position restricted by the first fixing portion, and wherein the first latching notch is positioned further away from the substrate than the second latching notch.

12. The electric connector of claim 11, wherein the terminal locking component further comprises a first locking plate extending along the first direction and one end of the first locking plate being connected to the substrate.

13. The electric connector of claim 12, wherein the terminal locking component comprises two first locking plates symmetrically arranged along a second direction perpendicular to the first direction.

14. The electric connector of claim 12, wherein, the main shell comprises a second through-slot structure connected with the housing, and further comprises two second locking plates extending along the first direction, wherein one end of the second locking plates is connected with the second through-slot structure, wherein the two second locking plates are symmetrically arranged along the second direction, wherein the second locking plate is at one side of the first locking plate which is closer to the second through-slot structure along the second direction, and wherein, the first locking plate is to make contact with the second locking plate when the end cover component has a position restricted by the second fixing portion.

15. The electric connector of claim 1, wherein the electric connector is a coaxial connector and wherein the main shell defines a single terminal channel.
